(19) United States
(12) Patent Application Publication
(10) Pub. No.: US 2024/0151836 A1
(43) Pub. Date: May 9, 2024

(54) CONTROLLING MEANS FOR A LIGHT DETECTION AND RANGING SYSTEM AND NON-TRANSITORY COMPUTER READABLE MEDIUMS

(71) Applicant: Intel Corporation, Santa Clara, CA (US)

(72) Inventors: Liron AIN-KEDEM, Kiryat Tivon (IL); Avi MEDLINSKY, Ramat Yishay (IL); Daniel GRODENSKY, Haifa (IL); Shachar GREENBERG, Nofit (IL)

(21) Appl. No.: 18/548,912

(22) PCT Filed: Mar. 18, 2022
(86) PCT No.: PCT/US2022/020864

§ 371 Date: Sep. 4, 2023

Related U.S. Application Data
(60) Provisional application No. 63/194,224, filed on May 28, 2021.

(51) Int. Cl. G01S 7/497; G01S 7/481; G01S 7/4911; G01S 7/4913; G01S 17/86

(52) U.S. Cl. CPC G01S 7/497; G01S 7/4815; G01S 7/4817; G01S 7/4911; G01S 7/4913; G01S 17/86

(57) ABSTRACT

Disclosed herein are methods, systems, and devices that relate to light detection and ranging (LIDAR). A controlling means for a LIDAR system includes a means for determining a current operational state of the LIDAR system regarding a predefined threshold state. The controlling means also switches the LIDAR system from a first operational mode to a second operational mode when the determined operational state exceeds the predefined threshold state. The second operational mode corresponds to an operational power of at least one operational means of the LIDAR system being lower than in the first operational mode.

### CROSS-REFERENCE

This non-provisional application claims priority to U.S. provisional application 63/194,224, filed on May 28, 2021, the entirety of which is fully incorporated herein by reference.

### TECHNICAL FIELD

This disclosure relates generally to a light detection and ranging (LIDAR) system.

### BACKGROUND

Power consumption and power dissipation in frequency modulated continuous wave (FMCW) LIDAR systems are critical issues for a high performance yet low cost LIDAR products.

### BRIEF DESCRIPTION OF THE DRAWINGS

Throughout the drawings, like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 exemplarily shows a vehicle having a light detection and ranging system in a schematic view;

FIG. 2 exemplarily shows a light detection and ranging system in a schematic view;

FIG. 3 exemplarily shows a light detection and ranging system in a schematic view;

FIG. 4A and FIG. 4B exemplarily show a scene of a light detection and ranging system in a schematic view;

FIG. 5 exemplarily shows a timing diagram of light sources of a light detection and ranging system; and

FIG. 6A and FIG. 6B show flow diagrams of methods to operate a light detection and ranging system.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects described herein are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures.

This disclosure provides a LIDAR system and a LIDAR sensor thereof with a reduced power consumption, which considerably influences the sensor cost, power dissipation solutions cost and form factor and platform range (especially electric car range is important). Thus, any savings in power may considerably impact multiple parameters of the solution all impact cost.

In a LIDAR system, a controlling means, e.g. a controller, a processor or processing unit, controls optical elements, electrical elements and/or electro-optical elements (also denoted as components) of the LIDAR system to reduce power of the LIDAR system, e.g. power and consumption including short term savings as well as longer term power reduction.

As an example, the controlling means may be configured to control electrical components and/or optical components of the LIDAR system regarding a reduction of power consumption. The controlling means may control and power light emitted by controlling a current, e.g. of electrical amplifiers and/or optical amplifiers. The controlling means may include a dynamic power level operation configured to reduce power consumption dynamically.

The LIDAR system may include an electrical amplifier (also denoted as eAmp) for amplifying electrical signals generated by an electro-optical component, e.g. a photodetector structure of the LIDAR system. The eAmp may be configured to support at least one first power mode and a second power mode, e.g. a light emission mode and a standby mode. The controller may dynamically select one of the power modes to operate.

Alternatively, or in addition, the controlling means may include one or more processing units having an algorithmic sampling and processing pipe.

Alternatively, or in addition, the controlling means may be configured to modulate and/or control the power of one or more light sources, e.g. laser(s).

Alternatively, or in addition, the LIDAR system may include a plurality of thermal sensors coupled to at least one of the electrical components and/or optical components of the LIDAR system, e.g. the photonic integrated circuit (PIC). The controlling means may be configured to receive thermal data from the one or more thermal sensors. The controlling means may be configured to trigger a reduction of power if needed based on a determined temperature of one or more optical and/or electrical components of the LIDAR system.

Alternatively, or in addition, the controlling means may be configured to determine an operational mode, e.g. a current scan mode from a plurality of scan modes, and/or to determine the position of a laser beam of the LIDAR system in the scene of the LIDAR system.

Alternatively, or in addition, the controlling means may be configured to analyze the scene of the LIDAR system, e.g. relatively stationary objects in the scene.

Regarding a spatial scan and/or temporal scan, the controlling means may be configured to determine points or point regions that are not of interest, e.g. in the scene outside the field of view, e.g. in a saw-tooth scan. Alternatively, or in addition, the controlling means may be configured to switch off the laser part of the time, reduce the output optical power, e.g. of one or more lasers, reduce the amplification of one or more semiconductor optical amplifiers (SOA), and/or the power of an algorithm pipe of the processing unit. As an example, the output optical power may be reduced or even zeroed of the LIDAR system at the time the beam is in an area of the scene that is not of interest.

Alternatively, or in addition, the controlling means may be configured to adjust the output optical power depending on the position of the beam in scene of the LIDAR system. As an example, output optical power may be based on one or multi-frame scene analysis, e.g. of a point cloud. Output optical power may be controlled during the scan and optimized per the scene. For example, if a large portion of the scene of the LIDAR system shows targets at a distance of 50 m which is much less than the maximum distance, e.g. a maximum distance of the LIDAR system may be 200 m, optical power can be reduced to a distance of 50 m. Thus, all targets can still be detected. As an example, the controlling means may be configured for a technique of periodic beacon or random beacon of full power frames or part of frame to monitor if new targets have appeared that are at higher distance, or to increase a probability of detection (PD).

Alternatively, or in addition, in vehicle applications, the controlling means may be configured to determine a driving mode of the vehicle of a plurality of drive modes. The controlling means may be configured to adjust the output optical power, e.g. reduced power, dependent on driving mode. As an example, in an urban driving mode the vehicle drives in relative low speed, the controlling means may adjust output optical power for reduced distance. Thus, output power and processing compute power can be reduce respectively. The controlling means may receive guidance from a host analysis, a scene analysis and/or speed calculation of the vehicle.

The controlling means may be configured to select a laser source from a plurality of laser source. As an example, a plurality of laser sources may be optically coupled to a PIC that are emitting a beam to the scene, e.g. outputting one at a time. The controlling means may control the laser sources such that laser sources that are not switched in the electro-optical components can be in reduced power mode, e.g. a stand-by mode. The controller may power up, e.g. wake up, the laser source a time period before it is switched in to the electro optical system, e.g. to stabilize and/or pre-distort for linearity the laser source prior to outputting the optical power. The controlling means may be configured to apply one or more or all of the above mentioned mechanisms.

Throughout this specification, a LIDAR system may be understood as a device configured to implement LIDAR sensing, and may include various components to carry out light emission, light detection, and data processing. A LIDAR system may include a light source (e.g., a laser source) and emitter optics to direct light into a field of view (FOV) of the LIDAR system, and may include receiver optics and a receiver (a detector) to collect and detect light from the field of view. The LIDAR system may further include a processing circuit configured to determine spatial information associated with the field of view of the LIDAR system based on the emitted and received light (e.g., the processing circuit may be configured to determine various properties of an object in the field of view based on the light that the LIDAR system emits and that the object reflects back towards the LIDAR system). Additionally or alternatively, the LIDAR system may be communicatively coupled with a processing circuit external to the LIDAR system, e.g. with a cloud-based processing circuit. As examples, the processing circuit may be configured to determine the distance of an object from the LIDAR system, the shape of the object, the dimensions of the object, and/or the like. The LIDAR system may further include one or more additional components to enhance or assist the LIDAR sensing, such as, only as examples, a gyroscope, an accelerometer, a Global Positioning System (GPS) device, and/or the like. A LIDAR system may also be referred to herein as LIDAR device, LIDAR module, or LIDAR apparatus.

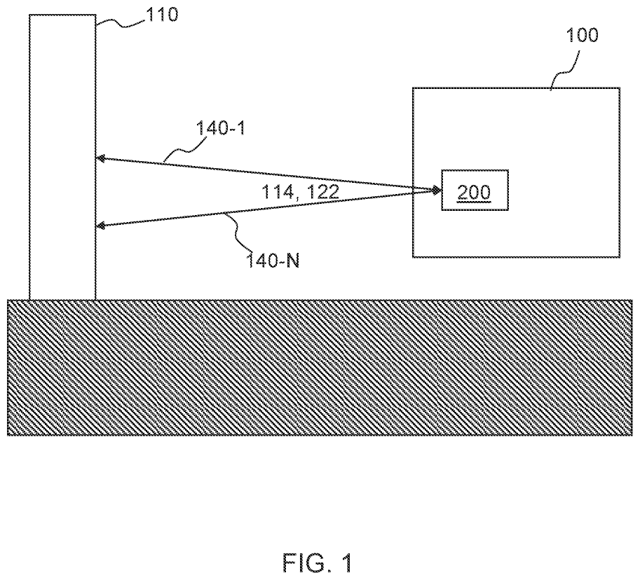

FIG. 1 illustrates a schematic diagram of a vehicle 100 having a LIDAR system 200 integrated therein, as an example. The vehicle 100 may be an unmanned/autonomous vehicle, e.g. unmanned/autonomous aerial vehicle, unmanned/autonomous automobile, or autonomous robot. In addition, LIDAR system 200 may be used in a mobile device such as a smartphone or tablet. The vehicle 100 may be an autonomous vehicle. Here, the LIDAR system 200 may be used to control the direction of travel of the vehicle 100. The LIDAR system 200 may be configured for obstacle detection, object depth detection or velocity detection outside of the LIDAR system 200 (also denoted as the scene of the LIDAR system 200), as an example. Alternatively or in addition, the vehicle 100 may require a driver or teleoperator to control the direction of travel of the vehicle 100. The LIDAR system 200 may be a driving assistant. As an example, the LIDAR system 200 may be configured for obstacle detection, e.g. determining a distance and/or direction and relative velocity of an obstacle (target 110) outside of the vehicle 100. The LIDAR system 200 may be configured, along one or more optical channels 140-i (with i being one between 1 to N and N being the number of channels of the PIC), to emit light 114 from one or more outputs of the LIDAR system 200, e.g. outputs of the light paths, and to receive light 122 reflected from the target 110 in one or more light inputs of the LIDAR system 200. The structure and design of the outputs and inputs of the light paths of the LIDAR system 200 may vary depending on the working principle of the LIDAR system 200. Alternatively, the LIDAR system 200 may be or may be part of a spectrometer or microscope. However, the working principle may be the same as in a vehicle 100.

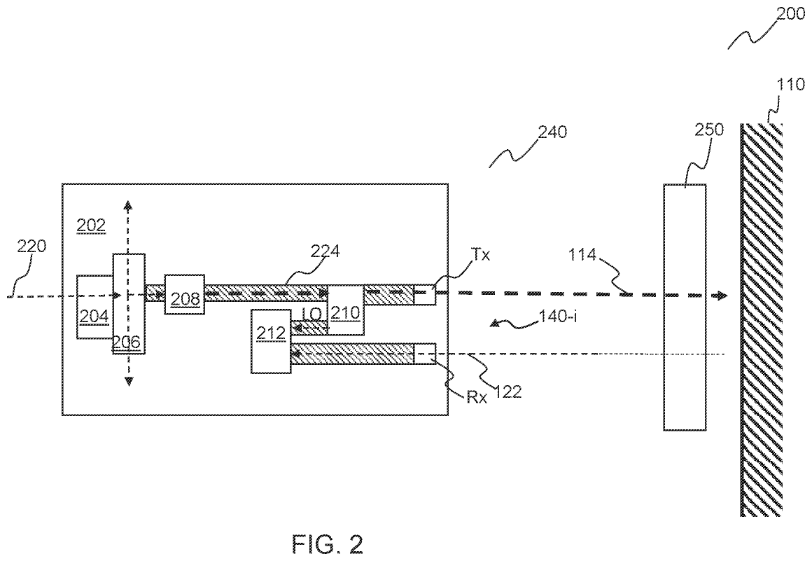

FIG. 2 illustrates a schematic diagram of a LIDAR system 200. The LIDAR system 200 includes a photonic integrated circuit substrate 202, e.g. a semiconductor substrate, e.g. a silicon-based substrate.

The semiconductor photonic integrated circuit 202 may be made of a semiconductor material, e.g. silicon. The semiconductor photonic integrated circuit 202 may be common substrate, e.g. at least for a plurality of optical channels 140-i. The term “integrated therein” may be understood as formed from the material of the substrate and, thus, may be different to the case in which elements are formed, arranged or positioned on top of a substrate. The term “located next” may be interpreted as formed in or on the same (a common) semiconductor photonic integrated circuit 202.

Each light path of the plurality of optical channels 140-i may include at least one optical output interface Tx configured to output the amplified light from the photonic integrated circuit 200. Each light path of the plurality of optical channels may include at least one photo detector structure 212 configured to receive light 122 from the outside of the photonic integrated circuit 200. The at least one photo detector structure 212 may be located next to the at least one light optical output interface Tx. The at least one photo detector structure 212 may be located next to the at least one optical output interface Tx, e.g. integrated in the common semiconductor photonic integrated circuit 202. The at least one light optical output interface Tx and the at least one photo detector structure 212 may be arranged on the same side of the photonic integrated circuit 200. The at least one photo detector structure 212 may include a photo diode and a beam combining structure (also denoted as optical combiner, optical beam combiner or optical mixer). The beam combining structure is configured to merge at least two individual beams to a single beam. The output of the beam combining structure may effectively be optically split, e.g. into two individual beams, in case a balanced photodiode pair is used.

One or more optical channels 140-i of the LIDAR system 200 may include further optical components 250, e.g. a scan mirror in the light path between a grating structure and the outside of the LIDAR system 200. A lens may be arranged between the PIC 240 and the grating structure. The lens may be any one of a converging lens, a collimating lens or a diverging lens. The grating structure may be a transmission grating, a reflective grating, or a grism. The grating structure may be optically arranged to guide light from the optical output interface Tx of the PIC 240 to the outside of the LIDAR system 200 and from the outside of the LIDAR system 200 to an optical photo detector structure 212.

Using a multiple (M) wavelength laser source and the grating structure, the number of LIDAR channels may be increased by a factor of M for a given PIC 240 to achieve a desired high number (>100) of vertical resolution elements or pixels. Hence, a high-performance coherent LIDAR system 200 is achieved.

The one or more optical output interfaces Tx may emit electromagnetic radiation, e.g. ultra-violet light, visible light, infrared radiation, terahertz radiation or microwave radiation (denoted as “light” throughout this specification) to different parts of the scene of the LIDAR system, e.g. at the same time or subsequently, e.g. by the grating structure and/or the lens structure along one or more optical channels 140-i. This way, light 114 emitted by the optical output interface Tx of the PIC 240 samples different portions of a target (not the same pixel) and/or different targets at the same time. Thus, light reflected 122 from the target and detected by a photo detector structure 212 of different optical channels 140-i contains information correlated to different portions of a target (not the same pixel) and/or different targets at the same time. In other words, a plurality of optical channels 140-i emit light into different directions in space using the grating. The target back reflects light 122 to the optical input interface Rx. This way, a mapping between the emitted light 114 and the information of the target may be enabled from the returned light 122.

The photonic integrated circuit 200 may include one or more optical channels 140-i. Thus, as an example, multiple (i being an element of 1 to N, N>10) vertical optical channels operating in parallel may be provided. Hence, a high (>1M pixels/s) overall or effective data rate may be enabled.

The LIDAR system 200 may include a plurality of light sources (also denoted as (coherent) electromagnetic radiation source) each configured to emit electromagnetic radiation having a wavelength/frequency different to the wavelength/frequency of the other light sources. The light source provides the light 220 to an optical input structure of the PIC 202. Through this specification any kind of usable of “electromagnetic radiation” is denoted as “light” for illustration purpose only and even though the electromagnetic radiation may be in the frequency range of visible light, infrared light/radiation, ultraviolet light/radiation, a terahertz spectrum and/or a microwave spectrum. The electromagnetic radiation may include a continuous wave and/or pulsed, e.g. a frequency modulated continuous wave (FMCW) in which the frequency of the received light is sweeped or chirped.

Alternatively or in addition, the LIDAR system 200 may include one or more light source(s) configured to emit electromagnetic radiation 220 of different/multiple wavelengths/frequencies. An optical filter, e.g. a low pass, high pass, band pass or notch filter may select a wavelength/frequency of a plurality of wavelengths/frequencies of a single light source. This way, by using wavelength multiplexing of spatially parallel optical channels in a PIC 240/waveguide structures of PIC 240, the detrimental effects due to fluctuating targets and TOF limitations are mitigated, thus enabling a coherent LIDAR with high optical resolution, high data rate, and long-range detection to be achieved.

The semiconductor photonic integrated circuit 202 may have integrated therein at least one light receiving input 204 and at least one optical splitter 206 to branch light received at the at least one light receiving input 204 to one of one or more optical channels 140-i.

A waveguide structure 224 may be in the form of a strip line or micro strip line. However, a waveguide structure 224 may also be configured as a planar waveguide. The waveguide structure 224 may be configured to guide electromagnetic radiation emitted from a light source coupled to the input 204 to the optical output interface Tx. The waveguide structure 224 may be formed from the material of the semiconductor photonic integrated circuit 202. Waveguide structures 224 may be optically isolated from each other. As an example, at least one waveguide structure 224 may be formed from semiconductor photonic integrated circuit 202.

Further, the PIC 240 may include an optical amplifier (SOA) 208 to amplify the light 114, 122 in the waveguide structure 224. In each light path of the one or more optical channels 140-N, the photonic integrated circuit 200 may include at least one amplifier structure 208 to amplify the light in the light path to provide an amplified light.

Further illustrated in FIG. 2 is a use of a part of the light from a beam splitter 210 as input signal for a photo detector structure 212 in the optical channel 140-i. Here, the input signal may be used as local oscillator (LO) for determining a difference between the light 114 emitted from the optical output interface Tx of the PIC 240 and light 122 received from the optical input interface Rx at the photo detector structure 212. Temporal fluctuations of the emitted light 114 may be considered in the received light 122 for each light path 140-i individually, thus allowing the LIDAR system 200 to detect and discriminate the optical frequency of the received light.

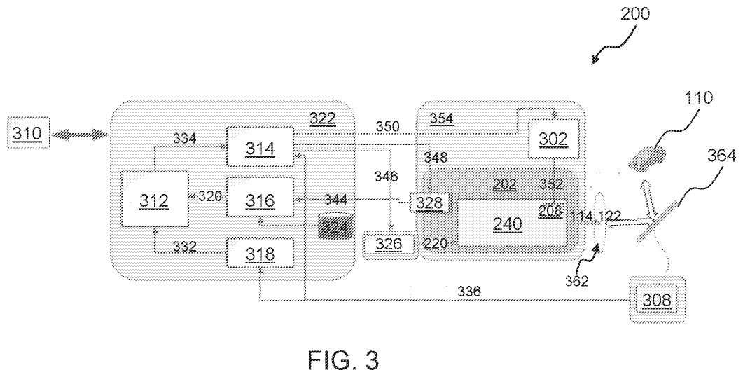

FIG. 3 illustrates a controlling means 322 of a LIDAR system 200, e.g. a processing unit 322. The controlling means 322 may be communicatively coupled to a host 310, e.g. a vehicle 100 or a processing unit of the vehicle 100. The controlling means 322 may be communicatively coupled to an electro-optical driver arrangement 354. The controlling means 322 may include a power reduction control 312, an optics control 314, a processing control 316 and a scan control 318.

In other words, the LIDAR system 200 may include a host 310, e.g. a host computer, communicatively coupled with at least one controlling means 322, e.g. a processor. The controlling means 322 may implement various control functions to control various components, e.g. optical components, of the LIDAR system 200, as will be described in more detail below. The controlling means 322 may include a plurality of processors, each implementing one or more of the control functions or exactly one processor implementing all control functions required in the LIDAR system 200.

The electro-optical driver arrangement 354 may include one or more electro-/optics driver(s), e.g. to control an amplification of one or more optical amplifier(s) and/or to control the scanning rate of a scanning mirror 364 (see also FIG. 2). As illustrated in FIG. 3, the scanning mirror 364 may be optically coupled to the PIC 240 through a lens 362 of the optical components.

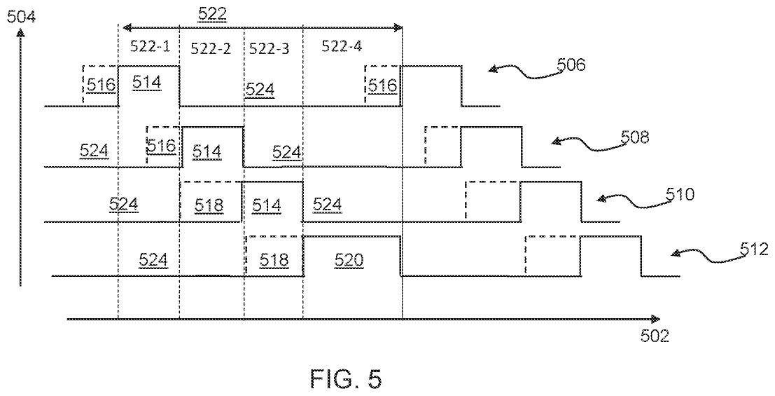

An electrical amplifier (eAmp) 328 may amplify the electrical signal from the photodetector structure (see FIG. 2) of the PIC 240 and transmit the amplified electrical signal 344 to the processing control 316 of the controlling means 322. However, the optics control 314 of the control means 322 may transmit an eAmp-control signal 348 to control the electrical amplification of the eAmp 328, e.g. to reduce the amplification or turn off the eAMP 328 when data is not relevant. This way, the power consumption of the eAmp 328. Alternatively, or in addition, the optics control may submit a laser-control signal 346 to one or more laser(s) 326 to switch off or control the light emission timing of one or more laser(s) (see also FIG. 5). Alternatively, or in addition, the optics control 314 may submit a driver-control signal 350 to one or more electro-optical driver (also denoted as driver circuitry) 302. The electro-optical driver 302 may submit an electro-optical control signal 352, e.g. to the SOA 208, to adjust the optical amplification, e.g. to reduce the amplification and, this way, the power consumption of the SOA 208. The optics control 314 may be configured to control the output optical power of the LIDAR system 200, e.g. to reduce the power consumption of the LIDAR system 200. Illustratively, the optics control 314 may influence the operational performance of one or more the transmission path(s) of the LIDAR system 200.

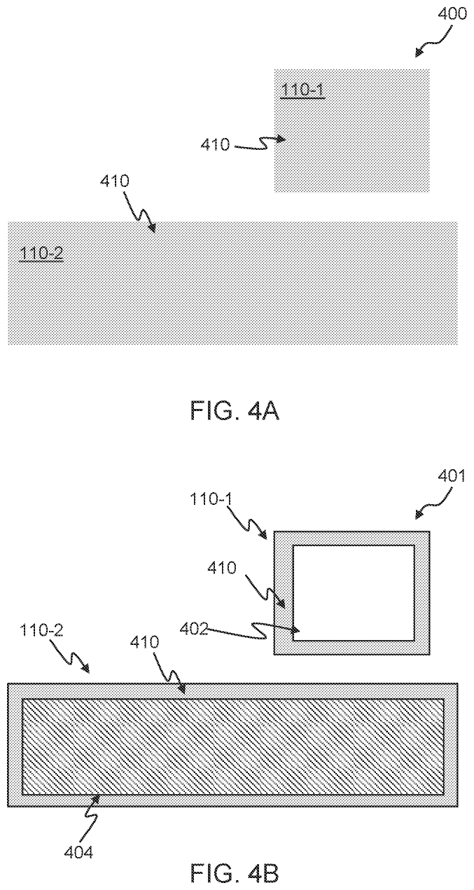

A scanning mirror sensor 308 coupled to the scanning mirror 364 may provide a position signal 336 indicating the position of the scanning mirror 364 to the optics control 314 and/or the scan control 318. The optics control 314 may use the position signal 336 to adjust the operational performance of at least one of the electro optical components of the LIDAR system 200, e.g. the laser source 326, the eAmp 328 and/or the electro-optical driver 302. The scan control 318 may provide a scan signal 332 to the power reduction control 312. The power reduction control 312 may adjust an operational performance based on the scan signal 332, e.g. adjust a processing based on the scanning position 336 (see also FIG. 4A, FIG. 46).

The processing control 316 may further receive information from multiple frames 324, e.g. stored in a memory, to determine a frame-to-frame difference. The processing control 316 may submit a processing control signal 320 to the power reduction control 312 based on the multi frame information 324 and the amplified electrical signal 344 from the eAmp 328. As an example, a frame-to-frame difference in the multi frame information 324 could be cause by a change of the operational mode of the LIDAR system 200 and the processing control 316 can address this difference by taking the multi frame information 324 into account.

Also, the processing control 316 may address the sampling and algorithmic processing pipe. Upon turning off the output it is possible to turn off the processing and reduce the consumed power.

The power reduction control 312 may provide an optics control signal 334 to the optics control 314 to adjust the operational performance of the LIDAR system accordingly.

FIG. 4A illustrates a scene 400 of a LIDAR system in a first frame. Here, the LIDAR system determines a first object 110-1, e.g. a vehicle, and a second object 110-2, e.g. a road, in the scene 400 in a first operational mode 410, e.g. using an operational performance of electro-optical components correlated with a range of 100 m to 200 m, as an example. The LIDAR system may determine that one or more parts of the scene 400 are relatively stationary, e.g. a road as second object 110-2 in a distance of 30 m to 60 m, and a vehicle as a first object 110-1 in a distance of 50 m to 60 m. Thus, the controlling means may adjust the operational mode of the LIDAR system for at least one of these parts to reduce the power consumption of the LIDAR system, as illustrated in FIG. 4B.

In other words, the LIDAR system 200 may be configured to try to find the maximum distance targets in the detected frames of the scene 400 (see e.g. frame N of a sequence of frames as shown in FIG. 4A). The frame 400 includes (illustrated in a very simplified manner) a second detected object 110-2 at a second distance from the LIDAR system 200 (e.g. a road 110-2 at a distance of approximately 30 m to 60 m) and a first detected object 110-1 at a first distance from the LIDAR system 200 (e.g. a car 110-1 at a distance of approximately 50 m to 60 m). In reaction thereto, the power reduction control function 312 may control the signal processing function 316 to analyze those regions in the immediately subsequently detected frame N+1, which correspond to the second detected object 110-2 and the first detected object 110-1 in frame N, in a reduced power mode, e.g. using a reduced resolution (see e.g. frame N+1 400 of a sequence of frames as shown in FIG. 46).

The operational performance, e.g. the output optical power and the effective range of the LIDAR system, may be reduced for parts 402, 404 of the first object 110-1 and the second object 110-2. The reduced operational performance 402, 404 may be the same or different for the first object 110-1 and the second object 110-2. As an example, in a first operational mode 410, the LIDAR system may operate in a distance range of 100 m to 200 m. In a second operational mode 402, the LIDAR system may operate in a distance range of 50 m to 60 m. In a third operational mode 404, the LIDAR system may operate in a distance range of 30 m to 60 m. The LIDAR system may operate in an operational mode having reduced operational performance for the time period of at least one frame.

FIG. 5 illustrates a timing diagram of light sources 506, 508, 510, 512 of a LIDAR system for one wave form period 522 (also denoted as cycle or repeated period). FIG. 5 illustrates power 504 as function of time 502. FIG. 5 shows subsequent optical output periods 514, 520 (also denoted as light emission power mode) of the light sources 506, 508, 510, 512 and wake-up periods 516, 518 (also denoted as laser preparation time or wake-up power mode) prior to the optical output periods 514, 520. During the wake-up period 516, 518, the light source may stabilize prior to the optical output period. In the optical output period, the LIDAR system emits light from the respective light source to the scene of the LIDAR system. The optical output periods 514, 520 and the wake-up periods 516, 518 may be the same or different depending on the characteristics of the light sources 506, 508, 510, 512. This way, the light sources can be operated in a stand-by mode 524 (also denoted as switch-off mode) to preserve energy.

In other words, FIG. 5 shows a timing diagram (time 502 versus power 504) illustrating a control sequence of a plurality of lasers of a LIDAR system, e.g. the LIDAR system 200. In other words, FIG. 5 shows a diagram for Laser Switching Power Optimization as controlled by the optics control function (see FIG. 3). The optics control function may control the one or more lasers in accordance with a predefined and pre-stored schedule. By way of example, the schedule instructs the optics control function to always only operate exactly one light source in the light emission power mode 514, 520 at a time. By way of example, the schedule instructs the optics control function to sequentially operate exactly one light source (e.g. one laser) in the light emission power mode 514, 520 to emit light while operating at least one other (e.g. all other) light source(s) (e.g. laser(s)) in a stand-by power mode 524, except for exactly one other light source (e.g. exactly one other laser), which, in accordance with the schedule, will be the light source to be operated in light emission power mode 514, 520 to emit light immediately subsequent to the currently light emitting light source operated in the light emission power mode 514, 520. This exactly one other light source will be prepared for light emission, e.g. by warming the light source up or by stabilizing the light source in its emission characteristics (in a wake-up power mode 516, 518).

By way of example, the sequence shown in FIG. 5 includes a repeated period (also referred to as cycle 522) of four time slots (a first time slot 522-1, a second time slot 522-2, an third time slot 522-3, a fourth time slot 522-4), wherein the optics control function controls each light source of the four light sources 506, 508, 510, 512 to emit light in exactly one time slot of a respective cycle 522.

As shown in FIG. 5, optics control function 314 controls
a first light source 510 (e.g. a first laser) of the four light sources to emit light in the third time slot 522-3 of a respective cycle 522 (and to operate in a light emission power mode 514, e.g. also referred to as or second power mode);
a third light source (e.g. a third laser) 506 and a fourth light source (e.g. a fourth laser) 508 to turn off in the third time slot 522-3 of a respective cycle 522 (and to operate in a stand-by power mode 524 with less power as compared with the light emission power mode 514, 520); and
a second light source (e.g. a second laser) 512 to, in the third time slot 522-3 of a respective cycle 522, prepare to emit light (and to operate in a warm-up or wake-up or stabilization power mode 516, 518).

Furthermore, optics control function may control
the second light source (e.g. the second laser) 512 of the four light sources to emit light in the fourth time slot 522-4 of a respective cycle 522 (and to operate in a light emission power mode 520);
the fourth light source (e.g. the fourth laser) 508 and the first light source 510 (e.g. the first laser) to turn off in the fourth time slot 522-4 of a respective cycle 510 (and to operate in a stand-by mode 524 with less power as compared with the light emission power mode); and
the third light source (e.g. the third laser) 506 to, in the third fourth slot 522-4 of a respective cycle 522, prepare to emit light (and to operate in a warm-up or wake-up or stabilization power mode 516).

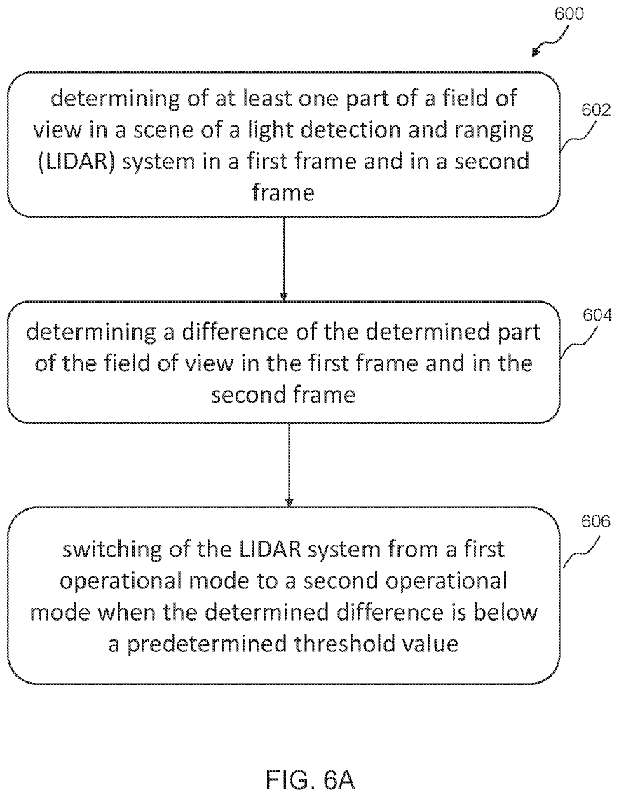

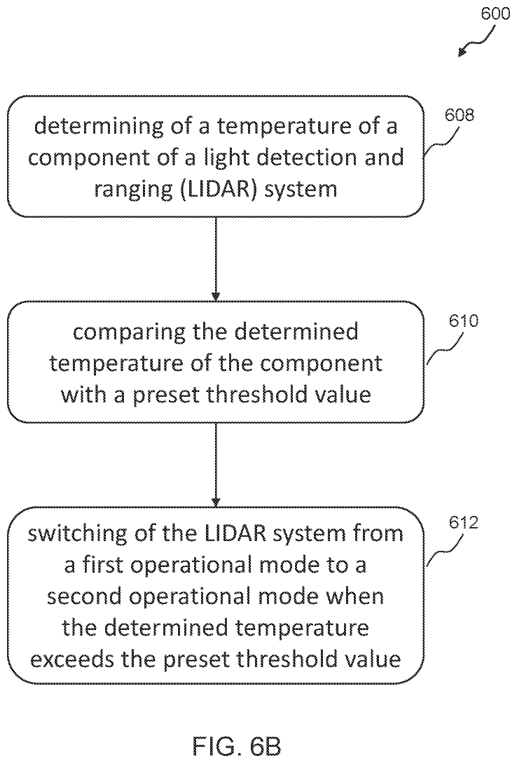

FIG. 6A and FIG. 6B show flow diagrams of methods to operate a light detection and ranging system.

As illustrated in FIG. 6A, the method 600 may include determining 602 at least one part of a field of view in a scene of a light detection and ranging (LIDAR) system 200 in a first frame and in a second frame. The method 600 may include determining 604 a difference of the determined part of the field of view in the first frame and in the second frame.

The method 600 may further include switching 606 the LIDAR system 200 from a first operational mode to a second operational mode when the determined difference is below a predetermined threshold value. The second operational mode may be associated with an operational power of at least one component of the LIDAR system 200 being lower than in the first operational mode.

Alternatively, or in addition, as illustrated in FIG. 6B, the method 600 may include determining 608 a temperature of a component of a light detection and ranging (LIDAR) system 200. The method 600 may further include comparing 610 the determined temperature of the component with a preset threshold value; and when the determined temperature exceeds the preset threshold value, switching 612 the LIDAR system 200 from a first operational mode to a second operational mode. The second operational mode may be associated with an operational power of at least one component of the LIDAR system 200 being lower than in the first operational mode.

In other words, referring to FIG. 1A to FIG. 6B, the controlling means 322 for a light detection and ranging (LIDAR) system 200, may include a control 312 for determining a current operational state of the LIDAR system 200 regarding a predefined threshold state. The predefined threshold state may be anything from a scanning velocity of the of the field of view, a resolution of the of the field of view, a distance range in the field of view that is covered by the LIDAR system, the angular rang of the field of view that is covered by the LIDAR system, a scanning direction of the field of view in which the LIDAR system emits light, a sampling rate of one or more processor(s), a gain of one or more electrical amplifier(s), a frame-to-frame change in the scene of the LIDAR system (also denoted as change of information), a gain one or more optical amplifier(s), and/or any combination thereof.

When the determined operational state exceeds the predefined threshold state, the controlling means 322 will switch the LIDAR system 200 from a first operational mode to a second operational mode. Exceeding of the predefined threshold state may be increase or a decrease of a value regarding a predefined value depending on the specific an operational state. As an example, in case the change of the scene or a part of the scene in the FOV of the LIDAR system is less than a predefined change, the LIDAR system may switch from the first operational mode to the second operational mode that corresponds to an operational power reduction. The second operational mode may be associated with an operational power of at least one operational means 326, 328, 358 of the LIDAR system 200 being lower than in the first operational mode. The operational power depends on the respective component. As an example, the operational power may be sampling rate for a processor, a scanning velocity for the light beam; an angular range of the field of view, a light emission time period of the LIDAR system, a scanning dircetion, as examples.

This disclosure provides a controlling scheme to control optical and electrical elements of a LIDAR system to reduce power of the sensor—both power and consumption (short term savings as well as longer term power reduction). Illustratively, the LIDAR system is getting information from scene analysis and scan mode of the system and adopts the emitted power and the processing elements timed compute to optimize the overall power consumption of the system.

The Power Reduction scheme has several input sources and several controlled elements.

A brief summary of the elements involved is provided in the following:

Controlled Elements
Electro-Optics Drive—Controls and power of the emitted light through controlling the current. Equipped with dynamic power level operation allowing to reduce power consumption dynamically.
eAmp—Amplifier of the electrical signal generated by the optics. Equipped with standby and reduced power modes that can be selected dynamically.
Processing—Algorithmic sampling and processing pipe
Laser/s—modulated and power controlled Laser/s
Thermal Info—from various components (PIC for example) to trigger reduce power if needed based on system/components temperature.

Source of information:
Scan Modes and Position of the LIDAR system
Scene Analysis
Laser & Optics timing
System Thermal Info

Various mechanisms to reduce power consumption of a LIDAR system are summarized below and will be explained in more detail in the remaining description:
On spatial or temporal scan where data is not interesting (outside Field Of View for example) or Lasers are off part of the time—output optical power (Lasers, SOAD) and algorithmic processing pipe are reduced or even zeroed at that time (example saw-tooth scan).
Scene Dependent emitted power—based on one or multi-frame scene (point cloud) analysis—emitted light power is controlled during the scan and optimized per the scene. For example—if a large portion of the scene shows targets at 50 m distance which is much less than the max distance range (200 m for example)—optical power can be reduced and still all targets can be detected. A technique of periodic or random beacon of full power frames or part of frame to monitor if new targets have appeared that are at higher distance, or to increase Pd (Probability of Detection).
Drive Mode—reduced power dependent on driving mode—for Urban mode where a vehicle drives in lower speed and reduced distance range is permitted—output power and processing compute power can be reduce respectively. Guidance from a host (e.g. a host computer) or scene analysis and/or EGO speed calculation.
Laser Switching power optimization—for multiple Lasers output that are switched into the Photonic Chip (outputting one at a time)—Lasers that are not switched in can be in reduced power mode, but requires preparation before switched in (wake-up, stabilized and pre-distorted for linearity).
Combination—any combination of the above mechanisms can be combined.

In more detail, the LIDAR system 200 may be composed of Lasers, Optical Elements—light emitting (and processing), sampling and processing system and control system. The Power Reduction elements described herein compromise of few mechanisms, information inputs, and controlled elements.

LIDAR Way of operation:

The LIDAR system 200 will now described in more detail to show where the power reduction may be incorporated.

The LIDAR system 200 may include a host 202, e.g. a host computer, communicatively coupled with processing unit 316. The processing unit 316 may implement various control functions to control various components, e.g. optical components, of the LIDAR system 200, as will be described in more detail below. The at least one processor may include a plurality of processors, each implementing one or more of the control functions or exactly one processor implementing all control functions required in the LIDAR system 200.

The LIDAR system 200 may further include electro-optical driver arrangement 354, e.g. electro optical components, such as electro-optical driver 302 and signal amplifier(s) to drive a PIC 240 to emit (e.g. laser) light 220, e.g. via a lens structure including at least one lens 362 (e.g. a telecentric lens) and a scanning mirror 364, to the outside of the LIDAR system 200.

The LIDAR system 200 may further include one or more laser sources (e.g. one or more lasers, e.g. one or more FMCW lasers) 326 to emit laser light 220 into a waveguide (see FIG. 2) and then into the PIC 240, which, in accordance with the control provided by the controlling means 322 and the electro-optical driver 302, will receive the laser light 220 and emit the laser light 114, as described above. It is to be noted that the laser source 326 is only an example for a light source in general, which may be provided to emit coherent light.

The emitted coherent light 114 may be reflected by an object in the scene 110 e.g. by another vehicle, and received by the LIDAR system 200 again. A LIDAR sensor, e.g. including one or more photo diodes, which may be arranged in a row and/or in a column or in an array of a plurality of rows and/or a plurality of columns, each row or column including a plurality of photo diodes, may be configured to detect light received e.g. via the scanning mirror 364 and forwarded via the PIC 240 and one or more electronic amplifiers 328 (which may amplify the received signals) to a processing unit 316 for further (digital signal processing).

The controlling means 322 may implement one or more of the following control functions: power reduction control function (also denoted as power reduction control 312); optics control function (also denoted as optics control 226); signal processing function (also denoted as processing control 316); and scan control function (also denoted as scan control 318).

A scanning mirror sensor 308 may be configured to detect signals from the scanning mirror 364 representing the position of the scanning mirror 364 during the LIDAR scanning process and to provide the same to the processing unit 316, namely to the scan control function. The LIDAR system 200 may further include a memory storing one or a plurality of frames 324 as detected by the LIDAR sensor. The signal processing function may process the stored frames 324 using various algorithms, e.g. to detect objects in the frames which may form the basis of control of the vehicle 100.

The power reduction control function 312 may control the optics control function 314, and/or the signal processing function 316, and/or the scan control function 316 to reduce the power consumption of the LIDAR system 200 using the mechanisms as described above and as will be described further below.
Optics Control 314—the logic controlling the electro-optical driver arrangement 354, e.g. driving and signal amplification 302. On opportunities to reduce power—the power reduction control function 312 may control the optics control function 314 to reduce the output power or turn off the electrical amplifiers when data is not relevant.
Laser/s 326—Lasers inputs power—the power reduction control function 312 may control the optics control function 314 to turn off lasers 326 that are not shoot out at the moment to save power and re-enable them at the right time.
Processing—sampling and algorithmic processing pipe. the power reduction control function 312 may control the signal processing function 316, e.g. upon turning off the output (for any of the reasons detailed below)—to turn off the processing and reducing the consumed power.
eAmp—amplifiers 328 of the electrical signal coming out of the optics. The power reduction control function 312 may control the optics control function 314, upon turning off input channels based on scan mode or position, to turn off these amplifiers 328.

By way of example, the power reduction control function 312 may control the signal processing function 316 to operate in a reduced power mode based on a detected scene as analyzed from the frames 324 stored in the memory.

The operational state may include a distance to an object in a field of view of a scene of the LIDAR system 200.

The controlling means 322 operates the LIDAR system 200 in the second operational mode for the time period of at least one frame.

The current operational state may correlate to a velocity of the LIDAR system 200 towards a scene of the LIDAR system 200.

The at least one operational means 326, 328, 358 may be a light emitting means of the LIDAR system 200. The light emitting means provides a light beam emitted to the scene of the LIDAR system 200.

The second operational mode may include a standby-mode and a wake-up mode of the light emitting means in predetermined time periods prior to a next light emission period of the light emitting means.

The at least one operational means 326, 328, 358 may be an optical amplification means of the LIDAR system 200.

The at least one operational means 326, 328, 358 may be an electrical amplification means of the LIDAR system 200.

The LIDAR system 200 may include a processing means to process signals received from the scene of the LIDAR system 200, and wherein the operational power may be a sampling rate and/or a processing rate of the processing means.

The LIDAR system 200 may include at least one temperature sensing means thermally coupled to at least one electrical operational means and/or optical operational means 326, 328, 358 of the LIDAR system 200. The current operational state may be a temperature determined by the temperature sensing means.

A non-transitory computer readable medium may include instructions which, if executed by one or more processors, cause the one or more processors to: determine at least one part of a field of view in a scene of a light detection and ranging (LIDAR) system 200 in a first frame and in a second frame; determine a difference of the determined part of the field of view in the first frame and in the second frame; and when the determined difference may be below a predetermined threshold value, switch the LIDAR system 200 from a first operational mode to a second operational mode. The second operational mode may be associated with an operational power of at least one component of the LIDAR system 200 being lower than in the first operational mode.

Alternatively, or in addition, the non-transitory computer readable medium may include instructions which, if executed by one or more processors, cause the one or more processors to: determine a temperature of a component of a light detection and ranging (LIDAR) system 200; comparing the determined temperature of the component with a preset threshold value; and when the determined temperature exceeds the preset threshold value, switch the LIDAR system 200 from a first operational mode to a second operational mode. The second operational mode may be associated with an operational power of at least one component of the LIDAR system 200 being lower than in the first operational mode.

The determined part of the field of view may include a distance to an object in the scene.

The LIDAR system 200 operates in the second operational mode for at least one third frame.

The LIDAR system 200 operates in the second operational mode at least in the determined part of the field of view in the third frame. The third frame may be subsequent to the second frame.

The determined difference of the determined part of the field of view may correlate to a velocity of the LIDAR system 200 towards the scene.

The at least one component may be a light source of the LIDAR system 200. The light source provides a light beam emitted to the scene. The second operational mode may include a standby-mode and a wake-up mode of the light source in predetermined time periods prior to a next light emission period of the light source.

The at least one component may be an optical amplifier of the LIDAR system 200. The at least one component may be an electrical amplifier of the LIDAR system 200.

The LIDAR system 200 may include a processing unit to process signals received from the scene, and wherein the operational power may be a sampling rate and/or a processing rate of the processing unit.

The LIDAR system 200 may include at least one temperature sensor thermally coupled to at least one electrical and/or optical component of the LIDAR system 200.

The transitory computer readable medium may include instructions to determine a second temperature of the component in the second operational mode; comparing the determined second temperature of the component with a preset second threshold value; and when the determined second temperature exceeds the preset second threshold value, switch the LIDAR system 200 from a second operational mode to a third operational mode. The third operational mode may be associated with an operational power of at least one component of the LIDAR system 200 being lower than in the second operational mode. The LIDAR system 200 may include a critical temperature at which the LIDAR system 200 may be shut down. The preset second threshold value may be closer to the critical temperature than the threshold value associated with the transition from the first operational mode to the second operational mode.

In the following, various examples are provided that may include one or more aspects described above.

Example 1 is a controlling means for a light detection and ranging (LIDAR) system, including a means for determining a current operational state of the LIDAR system regarding a predefined threshold state; and when the determined operational state exceeds the predefined threshold state, switch the LIDAR system from a first operational mode to a second operational mode, wherein the second operational mode corresponds to an operational power of at least one operational means of the LIDAR system being lower than in the first operational mode.

In Example 2, the subject matter of Example 1 can optionally include that the operational state includes a distance to an object in a field of view or a continuous area of a field of view of a scene of the LIDAR system.

In Example 3, the subject matter of Example 1 or 2 can optionally include that the controlling means operates the LIDAR system in the second operational mode for the time period of at least one frame.

In Example 4, the subject matter of any one of Examples 1 to 3 can optionally include that the current operational state correlates to a velocity of the LIDAR system towards a scene of the LIDAR system.

In Example 5, the subject matter of any one of Examples 1 to 4 can optionally include that the first operational mode corresponds to a first scanning direction of a scene of the LIDAR system, and the second operational mode corresponds to a second scanning direction of the scene, wherein a movable component of the LIDAR system scans along the first direction and the second direction to scan the scene of the LIDAR system.

In Example 6, the subject matter of any one of Examples 1 to 5 can optionally include that the first operational mode corresponds to a first continuous area of a field of view of a scene of the LIDAR system, and the second operational mode corresponds to a second continuous area of the field of view of the scene of the LIDAR system, wherein a movable component of the LIDAR system scans through the first continuous area and the second continuous area.

In Example 7, the subject matter of any one of Examples 1 to 6 can optionally include that the at least one operational means is a light emitting means of the LIDAR system, wherein the light emitting means provides a light beam emitted to the scene of the LIDAR system.

In Example 8, the subject matter of Example 7 can optionally include that the second operational mode includes a standby-mode and a wake-up mode of the light emitting means in predetermined time periods prior to a next light emission period of the light emitting means.

In Example 9, the subject matter of any one of Examples 1 to 8 can optionally include a plurality of light sources as operational components of the LIDAR system; wherein, when a first light source of the plurality of light sources is in the first operational mode, at the same time, a second light source of the plurality of light sources is in a second operational mode corresponding to a stand-by mode or a switched-off mode, and/or a third light source of the plurality of light sources is in a second operational mode corresponding to a wake-up mode.

In Example 10, the subject matter of any one of Examples 1 to 9 can optionally include that the at least one operational means is an optical amplification means of the LIDAR system.

In Example 11, the subject matter of any one of Examples 1 to 10 can optionally include that the at least one operational means is an electrical amplification means of the LIDAR system.

In Example 12, the subject matter of any one of Examples 1 to 11 can optionally include that the LIDAR system includes a processing means to process signals received from the scene of the LIDAR system, and wherein the operational power is a sampling rate and/or a processing rate of the processing means.

In Example 13, the subject matter of any one of Examples 1 to 12 can optionally include that the LIDAR system includes at least one temperature sensing means thermally coupled to at least one electrical operational means and/or optical operational means of the LIDAR system, wherein the current operational state is a temperature determined by the temperature sensing means.

Example 14 is a non-transitory computer readable medium including instructions which, if executed by one or more processors, cause the one or more processors to: determine at least one part of a field of view in a scene of a light detection and ranging (LIDAR) system in a first frame and in a second frame; determine a difference of the determined part of the field of view in the first frame and in the second frame; and when the determined difference is below a predetermined threshold value, switch the LIDAR system from a first operational mode to a second operational mode, wherein the second operational mode corresponds to an operational power of at least one component of the LIDAR system being lower than in the first operational mode.

In Example 15, the subject matter of Example 14 can optionally include that the determined part of the field of view includes a distance to an object in the scene.

In Example 16, the subject matter of any one of Examples 14 or 15 can optionally include that the LIDAR system operates in the second operational mode for at least one third frame.

In Example 17, the subject matter of any one of Examples 14 to 16 can optionally include that the LIDAR system operates in the second operational mode at least in the determined part of the field of view in the third frame

In Example 18, the subject matter of Example 17 can optionally include that the third frame is subsequent to the second frame.

In Example 19, the subject matter of any one of Examples 14 to 18 can optionally include that the determined difference of the determined part of the field of view correlates to a velocity of the LIDAR system towards the scene.

In Example 20, the subject matter of any one of Examples 14 to 19 can optionally include that the at least one component is a light source of the LIDAR system, wherein the light source provides a light beam emitted to the scene.

In Example 21, the subject matter of Example 20 can optionally include that the second operational mode includes a standby-mode and a wake-up mode of the light source in predetermined time periods prior to a next light emission period of the light source.

In Example 22, the subject matter of any one of Examples 14 to 21 can optionally include that the at least one component is an optical amplifier of the LIDAR system.

In Example 23, the subject matter of any one of Examples 14 to 22 can optionally include that the at least one component is an electrical amplifier of the LIDAR system.

In Example 24, the subject matter of any one of Examples 14 to 23 can optionally include that the LIDAR system includes a processing unit to process signals received from the scene, and wherein the operational power is a sampling rate and/or a processing rate of the processing unit.

Example 25 is a non-transitory computer readable medium including instructions which, if executed by one or more processors, cause the one or more processors to: determine a temperature of a component of a light detection and ranging (LIDAR) system; comparing the determined temperature of the component with a preset threshold value; and when the determined temperature exceeds the preset threshold value, switch the LIDAR system from a first operational mode to a second operational mode, wherein the second operational mode corresponds to an operational power of at least one component of the LIDAR system being lower than in the first operational mode.

In Example 26, the subject matter of Examples 25 can optionally include that the LIDAR system includes at least one temperature sensor thermally coupled to at least one electrical and/or optical component of the LIDAR system.

In Example 27, the subject matter of any one of Examples 25 or 26 can optionally include that the determined part of the field of view includes a distance to an object in the scene.

In Example 28, the subject matter of any one of Examples 25 to 27 can optionally include that the LIDAR system operates in the second operational mode for at least one third frame.

In Example 29, the subject matter of any one of Examples 25 to 28 can optionally include that the LIDAR system operates in the second operational mode at least in the determined part of the field of view in the third frame.

In Example 30, the subject matter of Example 29 can optionally include that the third frame is subsequent to the second frame.

In Example 31, the subject matter of any one of Examples 25 to 30 can optionally include that the determined difference of the determined part of the field of view correlates to a velocity of the LIDAR system towards the scene.

In Example 32, the subject matter of any one of Examples 25 to 31 can optionally include that the at least one component is a light source of the LIDAR system, wherein the light source provides a light beam emitted to the scene.

In Example 33, the subject matter of Example 32 can optionally include that the second operational mode includes a standby-mode and a wake-up mode of the light source in predetermined time periods prior to a next light emission period of the light source.

In Example 34, the subject matter of any one of Examples 25 to 33 can optionally include that the at least one component is an optical amplifier of the LIDAR system.

In Example 35, the subject matter of any one of Examples 25 to 34 can optionally include that the at least one component is an electrical amplifier of the LIDAR system.

In Example 36, the subject matter of any one of Examples 25 to 35 can optionally include that the LIDAR system includes a processing unit to process signals received from the scene, and wherein the operational power is a sampling rate and/or a processing rate of the processing unit.

In Example 37, the subject matter of any one of Examples 25 to 36 can further optionally include instructions to determine a second temperature of the component in the second operational mode; comparing the determined second temperature of the component with a preset second threshold value; and when the determined second temperature exceeds the preset second threshold value, switch the LIDAR system from a second operational mode to a third operational mode, wherein the third operational mode corresponds to an operational power of at least one component of the LIDAR system being lower than in the second operational mode.

In Example 38, the subject matter of any one of Examples 25 to 37 can optionally include that the LIDAR system includes a critical temperature at which the LIDAR system is shut down, wherein the preset second threshold value is closer to the critical temperature than the threshold value associated with the transition from the first operational mode to the second operational mode.

Example 39 is a vehicle including a LIDAR system of any one of the Examples 1 to 38.

In Example 40, the subject matter of Example 39 can optionally include that the LIDAR system is an obstacle detection system.

Example 41 is a light detection and ranging system, including: a processor configured to determine whether the light detection and ranging system receives reflected signals from a predefined region; control at least one optical component of a plurality of optical components to operate in a second power mode if it is determined that the received reflected signals are reflected from an object in the predefined region, and to operate in a first power mode if it is determined that the received reflected signals are reflected from an object outside the predefined region, wherein the at least one optical component is operated with less power in the second power mode as compared with the first power mode. A power mode may also be denoted as operational power mode.

In Example 42, the subject matter of Example 41 can optionally include that the processor is further configured to control at least one optical component of a plurality of optical components to operate in the first power mode based on a time duration of the operation of the at least one optical component in the second power mode.

In Example 43, the subject matter of Example 41 or 42 can optionally include that the time duration includes a predefined time duration.

In Example 44, the subject matter of any one of Examples 41 to 43 can optionally include that the processor is further configured to control at least one optical component of a plurality of optical components to operate in the first power mode based on a predefined system-external event.

In Example 45, the subject matter of any one of Examples 41 to 44 can optionally include that the second power mode includes a first electrical power mode; wherein the first power mode includes a second electrical power mode.

In Example 46, the subject matter of any one of Examples 41 to 45 can optionally include that the second power mode includes a first optical power mode; wherein the first power mode includes a optical electrical power mode.

In Example 47, the subject matter of any one of Examples 41 to 46 can optionally include that the predefined region includes at least one of a predefined distance or a predefined angular field of view of the light detection and ranging system.

In Example 48, the subject matter of any one of Examples 41 to 47 can optionally include the plurality of optical components.

In Example 49, the subject matter of any one of Examples 41 to 48 can optionally include that the reduced power mode includes a stand-by mode of at least one of the optical components.

In Example 50, the subject matter of any one of Examples 41 to 49 can optionally include that the reduced power mode includes turning off at least one of the optical components.

In Example 51, the subject matter of any one of Examples 41 to 50 can optionally include that the plurality of optical components includes at least one of an optics driver circuit or an optics control amplifier.

In Example 52, the subject matter of any one of Examples 41 to 51 can optionally include optics of the light detection and ranging system.

In Example 53, the subject matter of any one of Examples 41 to 52 can optionally include that the plurality of optical components includes a photonic integrated system having a photonic semiconductor substrate having integrated therein a plurality of light paths each light path having input coupled to a light source of coherent electromagnetic radiation, an optical amplifier, and an output configured to emit the electromagnetic radiation to the outside of the light detection and ranging system.

In Example 54, the subject matter of any one of Examples 41 to 53 can optionally include that the plurality of optical components includes a plurality of light sources.

In Example 55, the subject matter of any one of Examples 41 to 54 can optionally include that the plurality of light sources includes a plurality of lasers.

In Example 56, the subject matter of any one of Examples 41 to 55 can optionally include that the processor is further configured to: sequentially operating exactly one light source in the first power mode to emit light in accordance with a predefined scheduling while operating at least one other light source in the second power mode; operating the light source to be immediately subsequently operated in the first power mode to emit light in accordance with the predefined scheduling in a third power mode to prepare this light source to emit light subsequent to the emitting light source.

In Example 57, the subject matter of any one of Examples 41 to 56 can optionally include that the plurality of optical components includes a sampling and received signal processing logic.

In Example 58, the subject matter of any one of Examples 41 to 57 can optionally include that the plurality of optical components includes at least one amplifier to amplify received signals.

In Example 59, the subject matter of any one of Examples 41 to 58 can optionally include that the plurality of optical components includes a movable scanning mirror optically arranged to guide the light from a light source to the outside of the light detection and ranging system.

Example 60 is a computer readable medium having instructions stored therein that, when executed by one or more processors, cause the processor to: determine whether the light detection and ranging system receives reflected signals from a predefined region; control at least one optical component of a plurality of optical components to operate in a second power mode if it is determined that the received reflected signals are reflected from an object in the predefined region, and to operate in a first power mode if it is determined that the received reflected signals are reflected from an object outside the predefined region, wherein the at least one optical component is operated with less power in the second power mode as compared with the first power mode.

In Example 61, the subject matter of Example 60 can optionally include that the second power mode includes a first electrical power mode; wherein the first power mode includes a second electrical power mode.

In Example 62, the subject matter of any one of Examples 60 to 61 can optionally include that the second power mode includes a first optical power mode; wherein the first power mode includes an optical electrical power mode.

In Example 63, the subject matter of any one of Examples 60 to 62 can optionally include that the predefined region includes at least one of a predefined distance or a predefined angular field of view of the light detection and ranging system.

In Example 64, the subject matter of any one of Examples 60 to 63 can optionally include that the reduced power mode includes a stand-by mode of at least one of the optical components.

In Example 65, the subject matter of any one of Examples 60 to 64 can optionally include that the reduced power mode includes turning off at least one of the optical components.

In Example 66, the subject matter of any one of Examples 60 to 65 can optionally include that the plurality of optical components includes at least one of an optics driver circuit or an optics control amplifier.

In Example 67, the subject matter of any one of Examples 60 to 66 can optionally include that the plurality of optical components includes a photonic integrated system having a photonic semiconductor substrate having integrated therein a plurality of light paths each light path having input coupled to a light source of coherent electromagnetic radiation, an optical amplifier, and an output configured to emit the electromagnetic radiation to the outside of the light detection and ranging system.

In Example 68, the subject matter of any one of Examples 60 to 67 can optionally include that the plurality of optical components includes a plurality of light sources.

In Example 69, the subject matter of any one of Examples 60 to 68 can optionally include that the plurality of light sources includes a plurality of lasers.

In Example 70, the subject matter of any one of Examples 60 to 69 can optionally include instructions that, when executed by one or more processors, cause the processor to: sequentially operating exactly one light source in the first power mode to emit light in accordance with a predefined scheduling while operating at least one other light source in the second power mode; operating the light source to be immediately subsequently operated in the first power mode to emit light in accordance with the predefined scheduling in a third power mode to prepare this light source to emit light subsequent to the emitting light source.

In Example 71, the subject matter of any one of Examples 60 to 70 can optionally include that the plurality of optical components includes a sampling and received signal processing logic.

In Example 72, the subject matter of any one of Examples 60 to 71 can optionally include that the plurality of optical components includes at least one amplifier to amplify received signals.

In Example 73, the subject matter of any one of Examples 60 to 72 can optionally include that the plurality of optical components includes a movable scanning mirror optically arranged to guide the light from a light source to the outside of the light detection and ranging system.

Example 74 is a vehicle including a light detection and ranging system according to any one of claims 1 to 73.

In Example 75, the subject matter of Example 74 can optionally include the light detection and ranging system according to any one of claims 1 to 73, wherein the time duration is determined based on the speed of the vehicle.

In Example 76, the subject matter of Example 74 or 75 can optionally include that the time duration is determined to be a first time duration at a first speed of the vehicle and to be a second time duration at a second speed of the vehicle, wherein the first speed is higher than the second speed and the first time duration is shorter than the second time duration.

Example 77 is a sensor system including a light detection and ranging system according to any one of claims 1 to 76.

Example 78 is a light detection and ranging system, including: means for determining whether the light detection and ranging system receives reflected signals from a predefined region; means for controlling at least one optical component of a plurality of optical components to operate in a second power mode if it is determined that the received reflected signals are reflected from an object in the predefined region, and to operate in a first power mode if it is determined that the received reflected signals are reflected from an object outside the predefined region, wherein the at least one optical component is operated with less power in the second power mode as compared with the first power mode.

The word “exemplary” is used herein to mean “serving as an example, instance, or illustration.” Any example or design described herein as “exemplary” is not necessarily to be construed as preferred or advantageous over other examples or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The terms “processor” or “controller” as, for example, used herein may be understood as any kind of technological entity that allows handling of data. The data may be handled according to one or more specific functions that the processor or controller execute. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “connected” can be understood in the sense of a (e.g. mechanical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

While the above descriptions and connected figures may depict electronic device components as separate elements, skilled persons will appreciate the various possibilities to combine or integrate discrete elements into a single element. Such may include combining two or more circuits from a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A light detection and ranging (LIDAR) system comprising a controller configured to:
determine a current operational state of the LIDAR system regarding a predefined threshold state; and
switch the LIDAR system from a first operational mode to a second operational mode when the current operational state exceeds the predefined threshold state, wherein the second operational mode corresponds to an operational power of at least one operational component of the LIDAR system being lower than in the first operational mode.

2. The LIDAR system of claim 1, wherein the current operational state comprises a distance to an object in a field of view or a continuous area of a field of view of a scene of the LIDAR system.

3. The LIDAR system of claim 1, wherein the controller operates the LIDAR system in the second operational mode for a time period of at least one frame.

4. The LIDAR system of claim 1, wherein a current operational state of the LIDAR system corresponds to a velocity of the LIDAR system towards a scene of the LIDAR system.

5. The LIDAR system of claim 1,
wherein the first operational mode corresponds to a first scanning direction of a scene of the LIDAR system, and the second operational mode corresponds to a second scanning direction of the scene, wherein a movable component of the LIDAR system scans along the first scanning direction and the second scanning direction to scan the scene of the LIDAR system.

6. The LIDAR system of claim 1,
wherein the first operational mode corresponds to a first continuous area of a field of view of a scene of the LIDAR system, and the second operational mode corresponds to a second continuous area of the field of view of the scene of the LIDAR system, wherein a movable component of the LIDAR system scans through the first continuous area and the second continuous area.

7. The LIDAR system of claim 1, wherein the at least one operational component is a light source of the LIDAR system, wherein the light source is configured to emit a light beam to a scene of the LIDAR system.

8. The LIDAR system of claim 7, wherein the second operational mode comprises a standby-mode and a wake-up mode of the light source in predetermined time periods prior to a next light emission period of the light source.

9. The LIDAR system of claim 1 further comprising a plurality of light sources as operational components of the LIDAR system,
wherein, when a first light source of the plurality of light sources is in the first operational mode, at a same time, a second light source of the plurality of light sources is in a second operational mode corresponding to a stand-by mode or a switched-off mode, and/or a third light source of the plurality of light sources is in a second operational mode corresponding to a wake-up mode.

10. The LIDAR system of claim 1, wherein the at least one operational component is an optical amplifier of the LIDAR system.

11. The LIDAR system of claim 1, wherein the at least one operational component is an electrical amplifier of the LIDAR system.

12. The LIDAR system of claim 1, wherein the LIDAR system comprises a processing unit configured to process signals received from the LIDAR system, wherein the operational power is a sampling rate and/or a processing rate of the processing unit.

13. The LIDAR system of claim 1, wherein the LIDAR system comprises at least one temperature sensor thermally coupled to at least one electrical operational component and/or optical operational component of the LIDAR system, wherein the current operational state is a temperature determined by the temperature sensor.

14. A non-transitory computer readable medium comprising instructions which, if executed by one or more processors, cause the one or more processors to:
determine at least one part of a field of view in a scene of a light detection and ranging (LIDAR) system in a first frame and in a second frame;
determine a difference of the at least one part of the field of view in the first frame and in the second frame; and
switch the LIDAR system from a first operational mode to a second operational mode when the difference is below a predetermined threshold value, wherein the second operational mode corresponds to an operational power of at least one component of the LIDAR system being lower than in the first operational mode.

15. The non-transitory computer readable medium of claim 14, wherein the at least one part of the field of view comprises a distance to an object in the scene.

16. The non-transitory computer readable medium of claim 14, wherein the LIDAR system operates in the second operational mode for at least a third frame.

17. The non-transitory computer readable medium of claim 16, wherein the LIDAR system operates in the second operational mode at least in the at least one part of the field of view in the third frame.

18. The non-transitory computer readable medium of claim 17, wherein the third frame is subsequent to the second frame.

19.-22. (canceled)

23. A controlling means for a light detection and ranging (LIDAR) system, the controlling means comprising:
a means for determining a current operational state of the LIDAR system regarding a predefined threshold state; and
a means for switching the LIDAR system from a first operational mode to a second operational mode when the current operational state exceeds the predefined threshold state, wherein the second operational mode corresponds to an operational power of at least one operational means of the LIDAR system being lower than in the first operational mode.

24. The controlling means of claim 23,
wherein the LIDAR system comprises at least one temperature sensing means thermally coupled to at least one electrical operational means and/or optical operational means of the LIDAR system, wherein the current operational state comprises a temperature determined by the temperature sensing means or
comprises a distance to an object in a field of view of a scene of the LIDAR system.
